(19) United States
(12) Patent Application Publication
(10) Pub. No.: US 2003/0023862 A1
(43) Pub. Date: Jan. 30, 2003

(54) Content distribution system

(75) Inventors: Shigeichiro Yamasaki, Kawasaki-shi (JP); Masatoshi Shiouchi, Kawasaki-shi (JP); Tadashige Iwao, Kawasaki-shi (JP); Yuji Wada, Kawasaki-shi (JP); Makoto Okada, Kawasaki-shi (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/235,756

(22) Filed: Sep. 6, 2002

Related U.S. Application Data
(63) Continuation-in-part of application No. 09/961,293, filed on Sep. 25, 2001.

(30) Foreign Application Priority Data
Apr. 26, 2001 (JP) 2001-129485
Apr. 24, 2002 (JP) 2002-121840

(51) Int. Cl. G06F 12/14

(52) U.S. Cl. 713/194

(57) ABSTRACT

A content distribution system involves a terminal unit of a user, a server of a third party and a terminal unit of a content distributor such as a copyright holder. The user's terminal unit is provided with a tamper-resistant device which can store data confidentially. The server of the third party supplies the user's terminal unit with data relating to a decrypting key needed to decode the encrypted content sent from the content distributor's terminal unit. Based on the supplied data from the third party, the decrypting key is produced confidentially within the tamper-resistant device.

### BACKGROUND OF THE INVENTION

1. Field of the invention

The present invention relates to a system of distributing digital productions, such as music, graphics and computer programs, through communications networks (such as the Internet) or by using portable storage mediums (such as optical disks). The present invention also relates to computer programs and hardware used for such a distribution system. The hardware includes an anti-tampering (tamper-resistive) unit and a server.

2. Description of the Related Art

As is known, many kinds of information are transmitted between communications terminals (e.g. personal computer) through the existing communications networks including the Internet. Such information includes music, graphics or computer programs for example. The creators (or copyright holders) of these artificial items or software (called the “content” hereinafter) may wish to distribute his or her productions to as many people as possible. The content receivers may be required to pay a certain amount of money before they can enjoy the distributed contents.

One way for allowing only legitimate receivers (i.e., receivers having paid the required money) to enjoy the content is to use cryptography. Specifically, first the transmitter transforms the content into a cipher by virtue of a key, and then transmits the cipher to the legitimate receiver through the communications network. Together with the encrypted content, the receiver is also provided with a secret key for decrypting the cipher. To avoid abuse, the secret key should be safely handed out to the legitimate receiver.

Conventionally, use may be made of an “escrow” service for ensuring that the required payment is to be made and that the transaction of the decrypting key is to be carried out safely between the content transmitter and the content receiver. The escrow service needs an intermediary approved by both the transmitter and the receiver. Typically, the intermediary is a banking institution. The authorized intermediary settles accounts for the payment of the content. After confirming that the requested payment has been made, the intermediary provides the content receiver with the decrypting key.

The escrow service can be utilized in various situations. For instance, it may be employed when an individual or a small company wishes to distribute contents, or when contents are sold at an auction, or when contents are sold by a P2P (peer to peer) transaction which is currently coming into wide use. As is known, in a P2P transaction, contents are transmitted from one terminal to another without using a server.

Unfavorably, the conventional escrow service suffers the abusing of the decrypting key supplied to the content receiver. Specifically, the conventional system has no means of preventing a legitimate receiver of the secret key from lending the obtained key to a person unauthorized to use the key. Therefore, the unauthorized person can easily decode the encrypted content using the decrypting key, and access the hidden information without making the payment.

### SUMMARY OF THE INVENTION

The present invention has been proposed under the circumstances described above. It is, therefore, an object of the present invention to provide a content distribution system whereby a license key is reliably concealed. Another object of the present invention is to provide a tamper-resistant device, a server and a computer program used for such a system.

According to a first aspect of the present invention, there is provided a content distribution system which includes: a data-processing apparatus of a user for receiving a content supplied from a content distributor; a data-processing apparatus of a third party trusted by both the content distributor and the user; and a communications network connecting the data-processing apparatuses of the user and the third party for mutual data communication. The data-processing apparatus of the user is provided with a tamper-resistant device storing data inaccessible from outside. The data-processing apparatus of the third party transmits first data to the data-processing apparatus of the user, where the first data relates to an encryption key that decodes a cipher generated by the content distributor. The encryption key is obtained only within the tamper-resistant device. The tamper-resistant device decodes the cipher by using the first data from the data-processing apparatus of the third party.

According to a second aspect of the present invention, there is provided a content distribution system which includes: a data-processing apparatus of a content distributor that transmits a content; a data-processing apparatus of a user that receives the content; a data-processing apparatus of a third party trusted by both the content distributor and the user; and a communications network connecting the data-processing apparatuses of the content distributor, the user and the third party for mutual data communication. The data-processing apparatus of the content distributor supplies a cipher to the data-processing apparatus of the user. The data-processing apparatus of the user is provided with a tamper-resistant device storing data inaccessible from outside. The data-processing apparatus of the third party transmits first data to the data-processing apparatus of the user, where the first data relates to an encryption key that decodes the cipher. The encryption key is obtained only within the tamper-resistant device. The tamper-resistant device decodes the cipher by using the first data from the data-processing apparatus of the third party.

Preferably, the data-processing apparatus of the third party stores a public key and a secret key. The public key is transmitted to the data-processing apparatus of the content distributor as required by the data-processing apparatus of the content distributor. The data-processing apparatus of the content distributor encodes the encryption key by using the public key from the data-processing apparatus of the third party. The encoded encryption key is transmitted to the data-processing apparatus of the user. The data-processing apparatus of the user causes the tamper-resistant device to generate second data based on the encoded encryption key from the data-processing apparatus of the content distributor. The second data is transmitted to the data-processing apparatus of the third party. The data-processing apparatus of the third party generates the first data based on the secret key and the second data supplied from the data-processing apparatus of the user.

Preferably, the system of the present invention further includes an additional third party, wherein the tamper-resistant device divides the second data into pieces one of which is received by a relevant one of the third parties.

Preferably, the tamper-resistant device allows mixing of a random number component in generating the second data based on the encoded encryption key, while also allowing removal of the random number component from the first data in decoding the cipher by using the first data.

Preferably, the tamper-resistant device stores information on the public key in a form of a digital certificate by an authentication agency. The tamper-resistant device is supplied to the user after the user is identified by the authentication agency. The data-processing apparatus of the third party confirms the identification of the user based on the public key information supplied in the form of the digital certificate from the data-processing apparatus of the user.

According to a third aspect of the present invention, there is provided a tamper-resistant device used in a content distribution system, where the system includes a data-processing apparatus of a content distributor to supply an encrypted content, a data-processing apparatus of a user to receive the supplied content, a data-processing apparatus of a third party which is trusted by both the content distributor and the user and supplies data on a key to decode the encrypted content, and a communications network connecting the respective data-processing apparatuses to each other for mutual data communication. The tamper-resistant device may include: a memory storing data inaccessible from outside; a key obtainer that restores the decoding key based on the key data supplied from the data-processing apparatus of the third party; and a decoder that decodes the encrypted content by using the decoding key restored by the key obtainer.

According to a fourth aspect of the present invention, there is provided a server used in a content distribution system, where the system includes a data-processing apparatus of a content distributor to supply an encrypted content, a data-processing apparatus of a user to receive the supplied content, a data-processing apparatus of a third party trusted by both the content distributor and the user, a communications network connecting the respective data-processing apparatuses to each other for mutual data communication, and a tamper-resistant device provided on the data-processing apparatus of the user for storing data inaccessible from outside. The server works as the data-processing apparatus of the third party. The server may includes: a data generator that generates first data relating to a key to decode the encrypted content from the data-processing apparatus of the content distributor, the decoding key being generated only within the tamper-resistant device; a data distributor that sends the first data to the data-processing apparatus of the user via the communications network.

According to a fifth aspect of the present invention, there is provided a computer program used in a content distribution system, where the system includes a data-processing apparatus of a content distributor to supply an encrypted content, a data-processing apparatus of a user to receive the supplied content, a data-processing apparatus of a third party trusted by both the content distributor and the user, a communications network connecting the data-processing apparatuses of the content distributor, the user and the third party for mutual data communication, and a tamper-resistant device provided on the data-processing apparatus of the user. The tamper-resistant device stores data inaccessible from outside. The computer program is prepared for controlling the data-processing apparatus of the third party, and includes: a data generation program for generating, first data relating to a key that decodes the encrypted content from the data-processing apparatus of the content distributor, the decoding key being generated only within the tamper-resistant device; and a data transmission program for sending the first data to the data-processing apparatus of the user via the communication network.

According to a sixth aspect of the present invention, there is provided a content distribution process performed in a system that comprises a data-processing apparatus of a user to receive an encrypted content supplied from a content distributor, a data-processing apparatus of a third party trusted by both the content distributor and the user, and a communications network connecting the data-processing apparatuses of the user and the third party for mutual data communication. The content distribution process includes the steps of: causing the data-processing apparatus of the user to issue an instruction to the data-processing apparatus of the third party for carrying out a procedure to make a payment for the content; causing the data-processing apparatus of the third party to send first data to the data-processing apparatus of the user when the payment for the content is made from an account of the user to an account of the third party, the first data serving to provides a key that decodes the encrypted content, the decoding key being available only within the data-processing apparatus of the user; and causing the data-processing apparatus of the user to decode the encrypted content using the first data supplied from the data-processing apparatus of the third party.

Preferably, the data-processing apparatus of the user is provided with a tamper-resistant device that stores data inaccessible from outside. The decoding of the encrypted content is performed by the tamper-resistant device.

Preferably, the data-processing apparatus of the third party stores a public key and a secret key. The data-processing apparatus of the user generates second data based on the decoding key. The decoding key is supplied from the content distributor and encrypted by the public key. The second data is transmitted to the data-processing apparatus of the third party. The data-processing apparatus of the third party generates the first data based on the second data and the secret key.

Preferably, the data-processing apparatus of the user allows mixing of a random number component in generating the second data based on the encrypted decoding key, and the random number component is removed from the first data when the first data decodes the encrypted content.

Preferably, the tamper-resistant device generates the second data and decodes the encrypted content.

Preferably, the data-processing apparatus of the third party carries out the payment procedure from the account of the third party to the account of the content distributor when the data-processing apparatus of the third party receives content confirmation notice from the data-processing apparatus of the user.

According to a seventh aspect of the present invention, there is provided a content distribution system comprising: a data-processing apparatus of a first user for receiving an encrypted version of a first content as plaintext from a content distributor; a data-processing apparatus of a 1st third party trusted by both the distributor and the first user; a data-processing apparatus of a second user for receiving an encrypted version of a second content as plaintext from the first user, the second content being produced based on the plaintext first content; a data-processing apparatus of a 2nd third party trusted by both the first user and the second user; and a communications network for connecting the data-processing apparatuses to each other.

In the above arrangement, the data-processing apparatus of the first user is provided with a first tamper-resistant device storing data inaccessible from outside, while the data-processing apparatus of the second user is provided with a second tamper-resistant device storing data inaccessible from outside. The data-processing apparatus of the 1st third party supplies the data-processing apparatus of the first user with first data relating to a first decrypting key to decode the encrypted first content from the distributor, wherein the first decrypting key is obtainable only within the first tamper-resistant device with the use of the first data. The first tamper-resistant device decodes the encrypted first content with the use of the first data from the data-processing apparatus of the 1st third party. The data-processing apparatus of the 2nd third party supplies the data-processing apparatus of the second user with second data relating to a second decrypting key to decode the encrypted second content from the first user, wherein the second decrypting key is obtainable only within the second tamper-resistant device with the use of the second data. The second tamper-resistant device decodes the encrypted second content with the use of the second data from the data-processing apparatus of the 2nd third party.

According to an eighth aspect of the present invention, there is provided a content distribution system comprising: a data-processing apparatus of a first user for receiving an encrypted version of a first content as plaintext from a content distributor; a data-processing apparatus of a second user for receiving an encrypted version of a second content from the first user, the second content being produced based on the encrypted first content; a data-processing apparatus of a 1st third party trusted by both the distributor and the second user; a data-processing apparatus of a 2nd third party trusted by both the first user and the second user; and a communications network for connecting the data-processing apparatuses to each other.

In the above arrangements, the data-processing apparatus of the second user is provided with a tamper-resistant device storing data inaccessible from outside. The data-processing apparatus of the 1st third party supplies the data-processing apparatus of the second user with first data relating to a first decrypting key to decode the encrypted first content from the distributor, wherein the first decrypting key is obtainable only within the tamper-resistant device. The data-processing apparatus of the 2nd third party supplies the data-processing apparatus of the second user with second data relating to a second decrypting key to decode the encrypted second content from the first user, wherein the second decrypting key is obtainable only within the tamper-resistant device. The tamper-resistant device decodes the encrypted second content with the use of the second data from the 2nd third party so that the encrypted first content is retrieved. Further, the tamper-resistant device decodes the encrypted first content with the use of the first data from the 1st third party.

According to a ninth aspect of the present invention, there is provided a content distribution system comprising: a data-processing apparatus of a first user both for receiving an encrypted version of a first content as plaintext from a first content distributor and for receiving an encrypted version of a second content as plaintext from a second content distributor; a data-processing apparatus of a 1st third party trusted by both the first distributor and the first user; a data-processing apparatus of a second user for receiving a third content from the first user, the third content being produced based on both the plaintext first content and the encrypted second content; a data-processing apparatus of a 2nd third party trusted by both the second distributor and the second user; a data-processing apparatus of a 3rd third party trusted by both the second distributor and the second user; and a communications network for connecting the data-processing apparatuses to each other.

In the above arrangements, the data-processing apparatus of the first user is provided with a first tamper-resistant device storing data inaccessible from outside, while the data-processing apparatus of the second user is provided with a second tamper-resistant device storing data inaccessible from outside. The data-processing apparatus of the 1st third party supplies the data-processing apparatus of the first user with first data relating to a first decrypting key to decode the encrypted first content from the first distributor, wherein the first decrypting key is obtainable only within the first tamper-resistant device. The first tamper-resistant device decodes the encrypted first content with the use of the first data from the 1st third party. The data-processing apparatus of the 2nd third party supplies the data-processing apparatus of the second user with second data relating to a second decrypting key to decode the encrypted second content from the second distributor, wherein the second decrypting key is obtainable only within the second tamper-resistant device. The data-processing apparatus of the 3rd third party supplies the data-processing apparatus of the second user with third data relating to a third decrypting key to decode the encrypted third content from the first user, wherein the third decrypting key is obtainable only within the second tamper-resistant device. The second tamper-resistant device decodes the encrypted third content with the use of the third data from the 3rd third party. As a result, the encrypted version of the second content is obtained. The second tamper-resistant device decodes this encrypted second content with the use of the second data from the 2nd third party.

According to a tenth aspect of the present invention, there is provided a content distribution system comprising: a first data-processing apparatus of a first user for receiving an encrypted version of a first content as plaintext from a first content distributor; a data-processing apparatus of a 1st third party trusted by both the first contributor and the first user; a second data-processing apparatus of the first user for receiving an encrypted version of a second content as plaintext from a second content distributor; a data-processing apparatus of a 2nd third party trusted by both the second distributor and the first user; a data-processing apparatus of a second user for receiving an encrypted version of a third content from the first user, the third content being produced based on both the plaintext first content and the plaintext second content; a data-processing apparatus of a 3rd third party trusted by both the first user and the second user; and a communications network for connecting the data-processing apparatuses to each other.

In the above arrangements, the first data-processing apparatus of the first user is provided with a first tamper-resistant device storing data inaccessible from outside, while the second data-processing apparatus of the first user is provided with a second tamper-resistant device storing data inaccessible from outside. Also, the data-processing apparatus of the second user is provided with a third tamper-resistant device storing data inaccessible from outside. The data-processing apparatus of the 1st third party supplies the first data-processing apparatus of the first user with first data relating to a first decrypting key to decode the encrypted first content from the first distributor, wherein the first decrypting key is obtainable only within the first tamper-resistant device. The first tamper-resistant device decodes the encrypted first content with the use of the first data from the 1st third party. The data-processing apparatus of the 2nd third party supplies the second data-processing apparatus of the first user with second data relating to a second decrypting key to decode the encrypted second content from the second distributor, wherein the second decrypting key is obtainable only within the second tamper-resistant device. The second tamper-resistant device decodes the encrypted second content with the use of the second data from the 2nd third party. The data-processing apparatus of the 3rd third party supplies the data-processing apparatus of the second user with third data relating to a third decrypting key to decode the encrypted third content from the first user, wherein the third decrypting key is obtainable only within the third tamper-resistant device. The third tamper-resistant device decodes the encrypted third content with the use of the third data from the 3rd third party.

According to an eleventh aspect of the present invention, there is provided a content distribution system comprising: a first data-processing apparatus of a first user for receiving an encrypted version of a first content as plaintext from a first content distributor; a second data-processing apparatus of the first user for receiving an encrypted version of a second content as plaintext from a second content distributor; a data-processing apparatus of a second user for receiving an encrypted version of a third content from the first user, the third content being produced based on both the encrypted first content and the encrypted second content; a data-processing apparatus of a 1st third party trusted by both the first distributor and the second user; a data-processing apparatus of a 2nd third party trusted by both the second distributor and the second user; a data-processing apparatus of a 3rd third party trusted by both the first user and the second user; and a communications network for connecting the data-processing apparatuses to each other.

In the above arrangements, the data-processing apparatus of the second user is provided with a tamper-resistant device storing data inaccessible from outside. The data-processing apparatus of the 1st third party supplies the data-processing apparatus of the second user with first data relating to a first decrypting key to decode the encrypted first content from the first distributor, wherein the first decrypting key is obtainable only within the tamper-resistant device. The data-processing apparatus of the 2nd third party supplies the data-processing apparatus of the second user with second data relating to a second decrypting key to decode the encrypted second content from the second distributor, wherein the second decrypting key is obtainable only within the tamper-resistant device. The data-processing apparatus of the 3rd third party supplies the data-processing apparatus of the second user with third data relating to a third decrypting key to decode the encrypted third content from the first user, wherein the third decrypting key is obtainable only within the tamper-resistant device. The tamper-resistant device decodes the encrypted third content from the first user with the use of the third data from the 3rd third party. The tamper-resistant device performs additional decoding on the decoded third content with the use of the first data from the 1st third party and the second data from the 2nd third party.

According to the present invention, the data-processing apparatus of a third party supplies the data-processing apparatus of a user with data relating to a decrypting key to decode the encrypted version of a content from a content distributor. Based on the data supplied from the third party, the decrypting key is produced confidentially within a tamper-resistant device of the user only. Thus, the decrypting key can be prevented from falling into the wrong hands.

Other features and advantages of the present invention will become apparent from the detailed description given below with reference to the accompanying drawings.

### BRIEF DESCRIPTION OF THE DRAWINGS

FIG. 1 is a diagram illustrating the basic concept of a content distribution system according to an embodiment of the present invention;

FIG. 2 shows the principal components of a terminal computer operated by a user of the content distribution system;

FIG. 3 illustrates a distribution protocol adopted for the content distribution system;

FIG. 4 shows an exemplary way of settling the charge for supply of a content;

FIG. 5 illustrates the principals of divisional secret preservation;

FIG. 6 is a diagram illustrating the basic concept of a content distribution system according to another embodiment of the present invention;

FIG. 7 is a diagram illustrating the basic concept of a content distribution system according to another embodiment of the present invention;

FIG. 8 is a diagram illustrating the basic concept of a content distribution system according to another embodiment of the present invention; and

FIG. 9 is a diagram illustrating the basic concept of a content distribution system according to another embodiment of the present invention.

### DETAILED DESCRIPTION OF THE PREFERRED EMBODIMENTS

The preferred embodiments of the present invention will be described below with reference to the accompanying drawings.

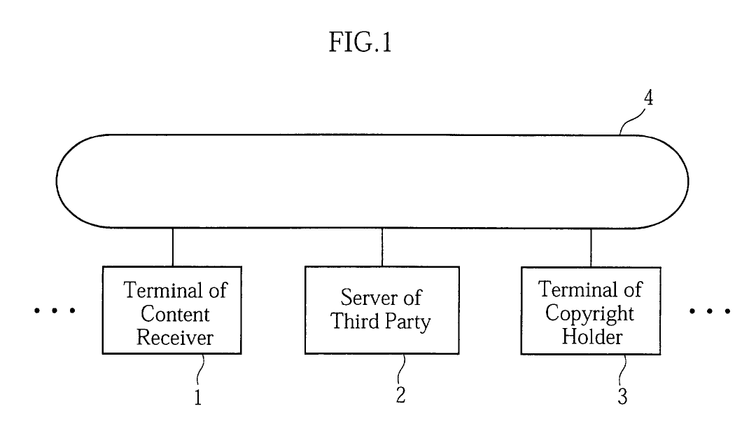

FIG. 1 illustrates the basic concept of a content distribution system embodying the present invention. As shown, this system includes terminals 1 of users (receivers of contents), a server 2 of a third party, terminals 3 of copyright holders (transmitters or distributors of contents), and a communications network 4. The terminals 1 and 3 are typically personal computers. The network 4 connects the terminals 1, the server 2, and the terminals 3 to each other. The network 4 may include the Internet, the servers of Internet connection agencies, the pubic telecommunication networks, and LANs (local area networks).

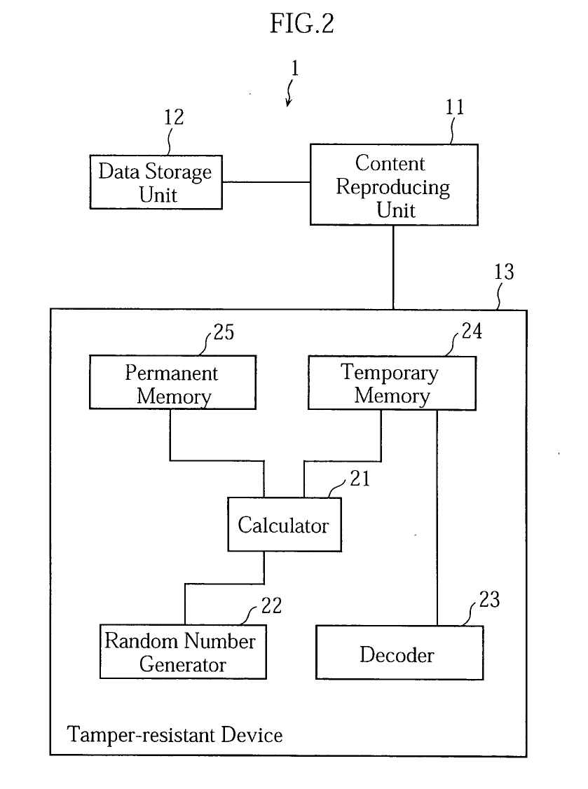

FIG. 2 shows the basic structure for the terminal 1 of a content receiver. As illustrated, the terminal 1 includes a content reproducing unit 11 and a data-storage unit 12. In association with the terminal 1, use is made of a tamper-resistant device 13 which is detachably connected to the terminal 1. As shown, the device 13 includes a calculator 21, a random number generator 22, a decoder 23, a temporary memory 24, and a permanent memory 25.

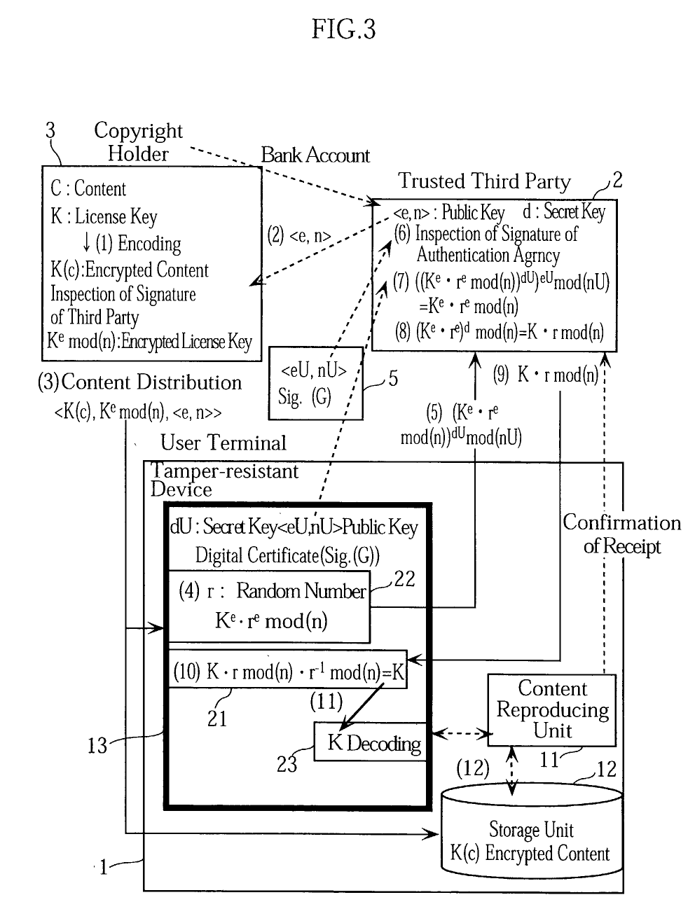

FIG. 3 illustrates a distribution protocol employed for the content distribution system of the present invention. In the figure, numeral 5 refers to an authentication agency which supplies a tamper-resistant device 13 to a legitimate content receiver. To this end, the authentication agency 5 confirms the identification of the receiver. The agency 5 is a trustable organization. Data stored in the device 13 is kept inaccessible to unauthorized people and also to the content receiver himself. The device 13 may be in the form of an IC card.

As noted above, the terminal 1 is typically a personal computer, though the present invention is not limited to this. For example, the terminal 1 may be a mobile telecommunication device (e.g. portable telephone), a computerized home video game having a data communication function, or a television set having a data processing function.

Referring back to FIG. 2, the content reproducing unit 11 reproduces the content supplied from the terminal 3 of a copyright holder. Initially, the supplied content is encrypted and stored in the data-storage unit 12. Then, the encrypted content is decoded for reproduction by a code system provided in the tamper-resistant device 13. The content reproducing unit 11 is realized by the CPU(central processing unit) incorporated in the terminal 1 of the receiver.

Typically, the data-storage unit 12 is realized by a hard disk device. Of course, the unit 12 may be provided with other rewritable nonvolatile memory (such as an optical disk) or volatile memory back-upped by a battery.

The calculator 21 calculates the residue of a large integer (1024-bit for example) raised to n-th power. Further, the calculator 21 calculates a key necessary for decoding the encrypted content supplied from the terminal 3 of a copyright holder. This calculation is performed based on the data supplied from the server 2, and the decoding is performed by the same algorithm as employed for encrypting the original plain content. The calculated key is stored in the temporary memory 24.

The random number generator 22 generates random numbers, as required.

The decoder 23 decrypts the encoded content stored in the data-storage unit 12. The decryption is performed with the use of the decrypting key calculated by the calculator 21.

The temporary memory 24 stores the random numbers generated by the random number generator 22. The memory 24 may be realized by a register or RAM(random access memory).

The permanent memory 25 stores a secret key and a corresponding public key prepared in accordance with public-key cryptography (asymmetric encryption). These keys are allotted exclusively for each tamper-resistant device 13 and stored in the form of a digital certificate signed by the authentication agency 5.

The server 2 is managed by a third party trustable to both the copyright holder of the content and the intended content receiver. Hereinafter, the third party may also be called “escrow organization.” The server 2 has the following functions. First, the server 2 holds a pair of keys (secret key and public key) prepared in accordance with public-key cryptography employing e.g. the RSA(Rivest-Shamir-Adleman) crypto-algorithm. These keys are specific to the third party. The public key is safely supplied to the copyright holder by a digital certification scheme for example. Second, the server 2 verifies the genuineness of the public key stored in the permanent memory 25 of the tamper-resistant device 13 supplied to the content receiver from the authentication agency 5. This verification is performed by inspecting the electronic signature in the digital certificate from the agency 5. Third, the server 2 calculates the residue of the n-th power of a large integer (1024-bit for example). Fourth, the server 2 issues a public key certificate which carries informational pieces concerning e.g. how to access the server 2. Preferably, the third party as an escrow organization may be a financial organization (a bank for example) or an agency aligned with a financial organization.

The terminal 3 of a content distributor (copyright holder) has a content-encrypting function, based on a single-key cryptosystem, to transform a content into a cipher by an encrypting key. This encrypting key is generated at the terminal 3 by the content distributor and is kept secret. The cipher is transmitted to the terminal 1 of the content receiver via the network 4.

In the illustrated embodiment, the content distributor has an account at the escrow organization to settle the payment for the supplied content. The terminal 3 of the content distributor may be a mobile telecommunications device (such as a portable telephone), or computerized home video device having a data communications function, or television set having a data processing function.

The authentication agency 5 is a reliable organization which verifies that the owner of a tamper-resistant device 13 is authorized to use the device. The permanent memory 25 of the tamper-resistant device 13 stores a secret key and the corresponding public key. For this public key, the organization 5 attaches a digital signature in the form of a public key certificate.

The overall procedure in the content distribution system of the present invention will now be described below.

First, a copyright holder operates the terminal 3 to transform the content C of his creation into a cipher K(c) by using the encrypting key (license key) K generated at the terminal 3. Further, using the terminal 3, the copyright holder obtains a public key <e,n> from the server 2 of the escrow organization in the form of a public key certification. Then, using the public key <e,n>, the copyright holder encodes the license key K as K^{e}mod(n), where K and n are integers which are relatively prime. The notation “K^{e}mod(n)” signifies the residue of the quotient K^{e}/n, where “K^{e}” is the e-th power of K. Then, using the terminal 3, the copyright holder transmits a data set <K(c), K^{e}mod(n), <e,n>> to the terminal 1 of the content receiver.

After obtaining the above data set from the terminal 3, the content receiver reproduces the original content C in the following manner. First, the content receiver stores the transmitted cipher K(c) in the data storage unit 12 of the terminal 1. Also, the content receiver inputs the encrypted license key K^{e}mod(n) and the public key <e,n> into the tamper-resistant device 13. Upon this data input, the random number generator 22 of the device 13 generates a random number r (this number and the integer n should be relatively prime). The random number r is stored in the temporary memory 24.

Then, the calculator 21 calculates (K^{e}r^{e})mod(n). Advantageously, the involvement of a random number r makes the license key K anonymous (concealed) . Further, using a secret key dU stored in the permanent memory 25, the calculator 21 calculates ((K^{e}r^{e})mod(n))^{du}mod(nU). The calculation result is utilized to verify, to the escrow organization, that the secret key dU is held in the tamper-resistant device 13. Then, the tamper-resistant device 13 transmits a data set <((K^{e}r^{e})mod(n))^{dU}mod(nU), (K^{e}mod(n))(r^{e}mod(n))> to the server 2 of the escrow organization. This transmission is performed based on access information contained in the public key certificate attached to the cipher K(c).

Upon receiving the data set <((K^{e}r^{e})mod(n))^{dU}mod(nU), (K^{e}mod(n))(r^{e}mod(n))> from the terminal 1, the server 2 examines whether the public key <eU,nU> of the content receiver is valid or not. For this, the server 2 inspects the digital signature of the authentication agency 5 attached to the public key certificate of the content receiver. When the public key <eU,nU> is found to be valid, the server 2 checks on the content receiver based on the data set <((K^{e}r^{e})mod(n))^{dU}mod(nU), (K^{e}mod(n))(r^{e}mod(n))> supplied from the terminal 1. Specifically, the server 2 calculates ((K^{e}r^{e})mod(n))^{dU}mod(nU)=(K^{e}r^{e})mod(n) by using (K^{e}r^{e})mod(n))^{dU}mod(nU), and then compares the calculation result with (K^{e}mod(n))(r^{e}mod(n)). When these two values coincide, the server 2 verifies that the distributor is a legitimate user. This verification is based on the fact that the above encryption can be performed only by the tamper-resistant device 13 incorporating the secret key dU corresponding to the public key <eU,nU>. When the content distributor has been found legitimate, the content receiver makes the required payment to the escrow organization. The escrow organization delays the registration of the payment into the account of the copyright holder until it receives the confirmation of receipt from the content receiver.

Using the secret key d of its own, the server 2 of the escrow organization decodes the information obtained from the terminal 1 of the content receiver. This decoding is performed in accordance with (K^{e}r^{e})^{d}mod(n)=(Kr)mod(n). (The public key <e,n> and the secret key d are determined to satisfy this equation.) Since the calculation result involves multiplication of the random number r, and in general, it is difficult to carry out the factorization in prime numbers for a large integer, it is virtually impossible to find the license key K from the above calculation result. The server 2 of the escrow organization sends (Kr)mod(n) to the terminal 1 of the content receiver.

Upon receiving the (Kr)mod(n) from the server 2, the terminal 1 of the content receiver supplies it to the tamper-resistant device 13. Then, the calculator 21 of the device 13 calculates the reciprocal of rmod(n) by using the random number r stored in the memory 24. The obtained reciprocal “r⁻¹mod(n)” is multiplied by (Kr)mod(n). This calculation results in the revealing of the secret key K. The obtained key K is temporarily stored in the memory 24. As is known in the art, the reciprocal of an integer which is relatively prime to the integer “n” can be calculated by a simple but effective method called the Euclidean algorithm.

The content reproducing unit 11 reproduces the content C. Specifically, the content reproducing unit 11 reads out the encoded content or cipher K(c) from the data-storage unit 12, and supplies it to the tamper-resistant device 13. Then, the decoder 23 of the device 13 decrypts the cipher K(c) with the use of the license key K stored in the temporary memory 24. Then, the decoded content (“plain content”) C is supplied to the content reproducing unit 11. Thus, the unit 11 reproduces the plain content C, and the result will be outputted by e.g. the display of the terminal 1 of the content receiver.

According to the above system, the license key K is kept secret within the tamper-resistant device 13. Thus, it is possible to prevent the content receiver to transmit the key K to other unauthorized persons.

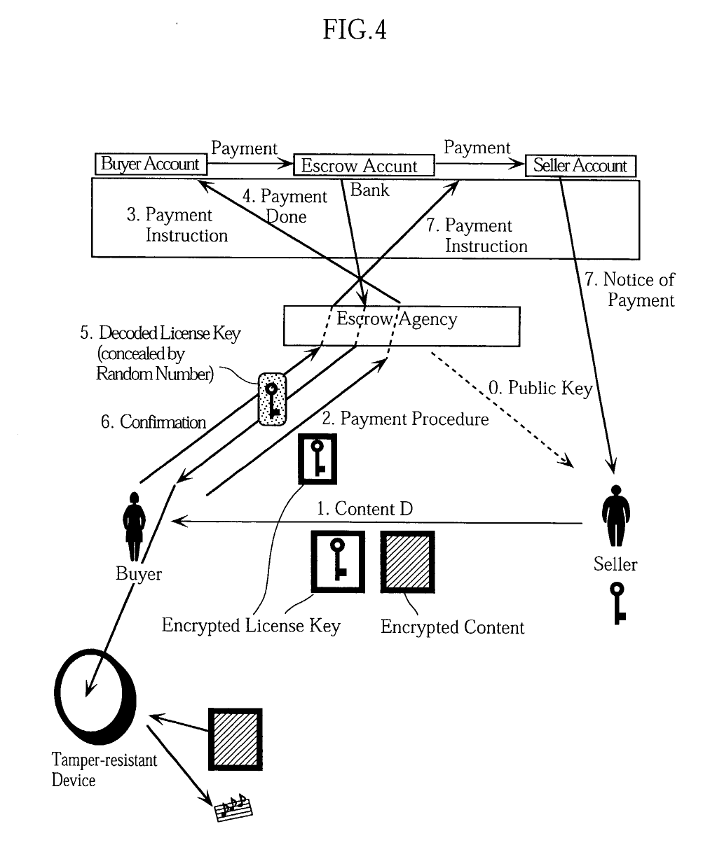

Reference is now made to FIG. 4 illustrating an exemplary way of settling the charge for using the content distribution system of the present invention.

First, a third party serving as escrow organization supplies a public key to the content transmitter (or seller). Precisely, the server 2 of the third party transmits a public key <e,n> to the terminal 3 of the content transmitter (copyright holder).

Then, the seller supplies the requested content C to the buyer (content receiver). Precisely, the terminal 3 of the copyright holder supplies the encrypted content K(c) and the encrypted license key (encryption key) K^{e}mod(n) to the terminal 1 of the buyer.

After obtaining the cipher K(c) and the license key, the buyer takes the necessary procedure for paying to the escrow organization. Precisely, the terminal 1 of the buyer transmits <((K^{e}r^{e})mod(n))^{dU}mod(nU), (K^{e}mod(n))(r^{e}mod(n))> to the server 2 of the third party.

Upon this, the third party issues an instruction to pay into the bank account of the third party from the bank account of the buyer. When the third party is notified by a contracted bank that the necessary payment has been made, the third party supplies the license key to the buyer. Precisely, the server 2 of the third party transmits (Kr)mod(n) to the terminal 1 of the buyer. Thereafter, the buyer can reproduce the content C using the tamper-resistant device 13.

When the reproduction of the content C has been successful, the buyer gives the third party notice to that effect.

After receiving the confirmation of the payment from the buyer, the third party issues an instruction to transfer the deposited money from the bank account of its own to the bank account of the seller (content transmitter). When this money transfer has been properly done, the contracted bank gives the seller notice to that effect.

As noted above, the digital signature anonymity technique by the “blind signature” algorithm can advantageously be applied to making the license key anonymous. In this manner, the decoding of the encrypted content C is successfully performed, while the encrypting license key K is kept secret to the third party and the users of the system.

According to the above-described embodiment, the escrow organization (third party) does not keep the license key K for the content C. Instead, the third party discloses the public key <e,n> of its own, and provides a calculation service using the secret key d corresponding to the public key. When the content receiver is found to be a legitimate user of the system (the legitimacy is confirmed by the notice of complete payment issued from the bank), the third party calculates data (Kr)mod(n) with the use of the secret key d and supplies it to the content receiver. The obtained data (Kr)mod(n) works as a license key K only within the tamper-resistant device 13 of the content receiver. Therefore, even the authorized content receiver (buyer) cannot see or make a copy of the data (Kr)mod(n). In this manner, it is possible to overcome the conventional problem of abusing the license key K for the content C by an unauthorized person.

Further, in the tamper-resistant device 13, random number disturbance is performed for making the license key anonymous, as in the blind signature schema. With the key kept anonymous, the third party performs the decoding calculation. Then, back in the tamper-resistant device 13 again, the random number components are removed for data decryption. In this manner, it is possible to hide the key K from the third party.

Further, the third party does not need to take charge of the key K. Therefore, the security cost to care for the key K can be zero. Advantageously for the copyright holders, the content distribution cost is reduced since they do not need to pay the key deposit cost to the third party.

Further, the public key <eU,nU>, which is paired with the secret key dU stored in the permanent memory 25 of the tamper-resistant device 13, is safely supplied by the trustable authentication agency 5. Specifically, the agency 5 supplies the public key to the content receiver in the form of e.g. a public key certificate after the agency 5 has checked the identification of the content receiver. In this manner, the third party can check the identification of the owner of the tamper-resistant device 13.

Further, according to the above-described embodiment, there is no need to use special storage units or reproduction units. This is advantageous to reducing the running cost of the system. Thanks to the reduced cost, even an individual copyright holder or small-scale company with little capital may be able to readily start a content distribution business.

Further, in a P2P transaction, the utilization of the tamper-resistant device 13 prevents the illegitimate duplication of the supplied content C and license key K. Also, the utilization of the third party ensures safe settlement of payment.

In the above embodiment, the content distribution from the receiver terminal 1 to the transmitter terminal 3 is performed through the communications network 4. The present invention, however, is not limited to this. For instance, a portable storage device (an optical disk for example) storing the content C may be shared out from the content transmitter to the content receiver.

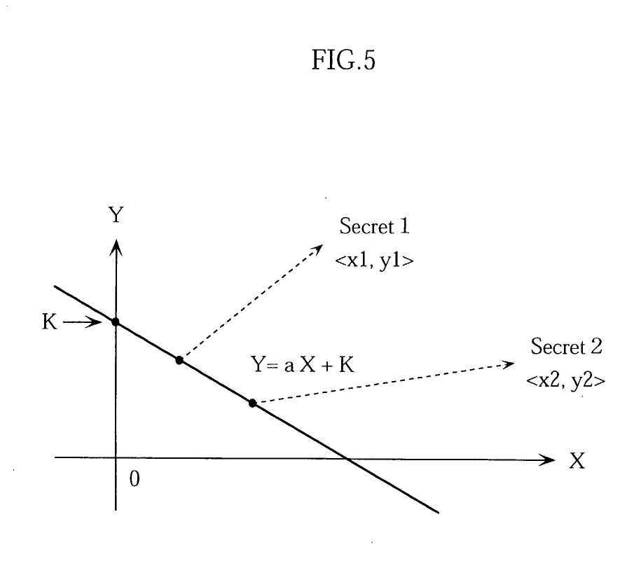

According to the present invention, more than one third party (escrow organization) may be involved in the system, so that the decrypting key will be kept secret even if the secret key of one (maybe more) third party is leaked out. To this end, specifically, each of the third parties may hold an allotted piece of data regarding one decrypting key. Then, as required, the third parties transmit their allotted pieces of data to the content receiver, thereby enabling the content receiver to access the hidden information of the content C. FIG. 5 illustrates the principle of such a secret dispersion system. In the illustrated example, the license key K is divided into two portions: Secret 1 <x1,y1> and Secret 2 <x2,y2>. The license key K can be reconstructed with both Secret 1 and Secret 2, but cannot with only one of them. The specific procedure may be as follows.

It is supposed that the tamper-resistant device 13 stores a secret key by the public-key cryptography, while the corresponding public key is revealed. Now the public key is represented by <nc,ec>, while the secret key by dc. The license key K is divided into two pieces of information by using a secret dispersion algorithm. For carrying out this division, the following formulas may be used: Y1=K+(A·X1)mod(P); Y2=K+(A·X2)mod(P), where X1, X2 and A are random numbers, while P is a prime number. According to these formulas, the license key K is divided into <X1,Y1> and <X2,Y2>. Then, Y1 is encrypted into (Y1)^{ec}mod(nc) by the public key <nc,ec> of the tamper-resistant device 13, while Y2 is encrypted into (Y2)^{e}mod(n). Then, the encrypted content, (Y1)^{ec}mod(nc), (Y2)^{e}mod(n), X1, X2 and P are transmitted to the content receiver. Then, (Y2)^{e}mod(n) is made anonymous by a random number within the tamper-resistant device 13, and transmitted to the server 2 of the third party. The server 2 sends back the decrypted results to the content receiver. The random number components are removed by the tamper-resistant device 13, and thus Y2 is obtained. Meanwhile, (Y1)^{ec}mod(nc) is decoded by the tamper-resistant device 13 with the use of the secret key dc, and thus Y1 is obtained. Thereafter, the tamper-resistant device 13 calculates Y1−((Y1−Y2)/(X1−X2))mod(P), from which the license key K results.

The above manner is advantageous to prohibiting the content receiver from obtaining the random number-free license key K without using the tamper-resistant device 13. (In an illegitimate case opposite to this, the content receiver may directly transmit K^{e}mod(n) to the server 2 of the third party for decoding, and may succeed in obtaining the random number-free license key K.) In addition, it is possible to prevent the third party from decrypting the key K. (Otherwise, the third party could decrypt the key K by referring to K^{e}mod(n) distributed with the content C.) This precaution may seem to be superfluous when the third party is a truly trustable organization. However, it may be better to make assurance doubly sure by dividing the key K in the above manner since the selection of a trustable third party cannot essentially overcome the unauthorized key decoding problem.

In the above-described embodiment, the supply of the public key <e,n> from the third party to the copyright holder is performed through the communications network 4. The present invention, however, is not limited to this. For instance, the key supply may be performed by way of a removable recoding medium such as a compact disc. Also, the RSA crypto-algorithm used in the above embodiment may be replaced with other suitable cryptosystems.

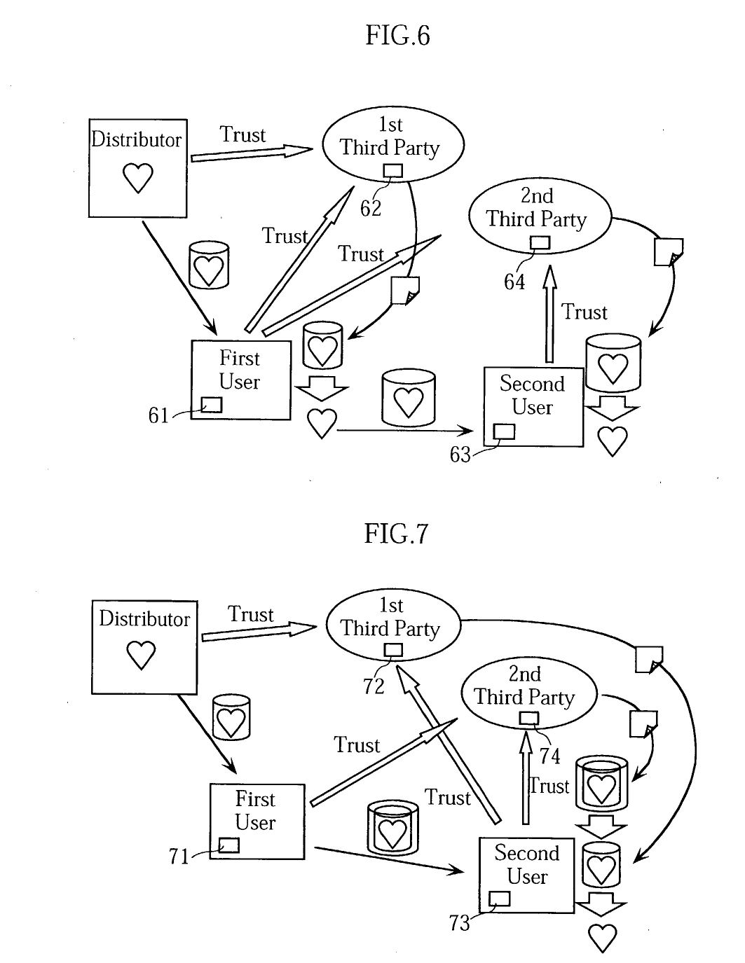

Referring now to FIG. 6, a content distribution system according to a second embodiment of the present invention will be described. This distribution system generally involves four data-processing apparatuses 61˜64 and a communications network (as shown in FIG. 1) to connect these data-processing apparatuses to each other.

Specifically, the data-processing apparatus 61, operated by a first user, receives an encrypted version of first content supplied from a content distributor. The data-processing apparatus 62 is operated by a 1st third party trusted by both the content distributor and the first user. The data-processing apparatus 63, operated by a second user, receives an encrypted version of second content sent from the first user. The second content, encrypted by the first user prior to the sending, may carry the same information as the first content or may be modified by the first user. The data-processing terminal 64 is operated by a 2nd third party trusted by both the first and the second users. Each of the data-processing apparatuses 61 and 63 of the first and the second users incorporates a tamper-resistant device like the one shown in FIG. 2.

In the above content distribution system, the data-processing apparatus 62 of the 1st third party supplies the data-processing apparatus 61 with first data that is needed to decode the encrypted first content. More specifically, based on the first data mentioned above, the first tamper-resistant device of the data-processing apparatus 61 produces a decrypting key to decode the encrypted first content. This decrypting key is kept confidential within the first tamper-resistant device, so that the decryption of the first content is possible only by the first tamper-resistant device. The content distribution from the distributor to the first user may be effected via a communications network or by a removable recording medium such as a compact disk.

The data-processing apparatus 64 of the 2nd third party supplies the data-processing apparatus 63 of the second user with second data needed to decode the encrypted second content. More specifically, based on the second data, the second tamper-resistant device of the data-processing apparatus 63 produces a decrypting key to decode the encrypted second content. This decrypting key is also kept confidential within the second tamper-resistant device, so that the decryption of the second content is possible only by the second tamper-resistant device.

In accordance with the content distribution system described above, it is possible to conduct a safe content transaction from the distributor to a purchaser (the second user) with a commission agent (the first user) acting therebetween. In this situation, the commission agent receives an encrypted content (“encrypted first content”) from a content distributor and decrypts the content with the use of content-decoding data (the “first data” above). Then, the commission agent encrypts the thus obtained plaintext content with his encrypting key. Finally, this encrypted content (“second content”) is supplied to the purchaser by the commission agent. As noted above, the second content may or may not carry the same information as the first content.

In the above example, the 1st and 2nd third parties are depicted as separate entities, though the present invention is not limited to this. For instance, the two third parties may be replaced with a single third party equipped with a computer capable of fulfilling the functions performed by the two data-processing apparatuses 62 and 64.

Reference is now made to FIG. 7 illustrating the basic concept of another content distribution system embodying the present invention.

The system of FIG. 7 is provided with four data-processing apparatuses 71˜74 connected to each other via a communications network (like the one shown in FIG. 1). The data-processing apparatus 71 is operated by the first user, who receives the encrypted first content from the content distributor. The data-processing apparatus 72 is operated by the 1st third party, which is trusted by both the distributor and the second user. The data-processing apparatus 73 is operated by the second user, who receives the encrypted second content generated from the encrypted version of the first content. The data-processing apparatus 74 is operated by the 2nd third party, which is trusted by both the first and the second users. In this embodiment again, the data-processing apparatus 73 of the second user incorporates a tamper-resistant device like the one shown in FIG. 2. The data-processing apparatus 71 of the first user, on the other hand, is not equipped with any tamper-resistant device since it does not perform any content decoding.

In operation, the data-processing apparatus 72 of the 1st third party supplies the data-processing apparatus 73 of the second user with data required for decoding the encrypted first content from the content distributor. More specifically, in accordance with the data sent from the 1st third party, the tamper-resistant device of the data-processing apparatus 73 generates a first decrypting key to decode the first content.

Likewise, the data-processing apparatus 74 of the 2nd third party supplies the data-processing apparatus 73 of the second user with data required for generating a second decrypting key to decode the encrypted second content from the first user.

The tamper-resistant device of the apparatus 73 decodes the second content with the use of the above-mentioned second decrypting key, thereby retrieving the encrypted version of the first content. Further, the tamper-resistant device performs additional decoding on the encrypted first content with the use of the above-mentioned first decrypting key, so that the first content as plaintext will be retrieved. At this stage, the decoding procedure for the target content is completed, whereby the desired original form of content is obtained.

In the above-described embodiment, the 1st third party needs to be trusted by the content distributor and the second user, but not by the first user. This is because the first user, differing from the content distributor and the second user, is not supplied with any important data from the 1st third party for decoding of the content.

The system of FIG. 7 is the same as the previous one (FIG. 6) in that the content supplied from an original distributor is first sent to a first user and then to a second user. However, the two systems differ in the following points. In the system of FIG. 6, as noted above, the encrypted content supplied from the distributor is first decrypted by the first user. Then, the plaintext content is encrypted by the first user and sent to the second user. Thus, at the time of the second user's receiving, the content is encrypted only “onefold.” On the other hand, in the system of FIG. 7, the first user is supposed to encrypt the first content, which has already been encrypted by the content distributor, without performing any decoding of the received content. Thus, the first user sends the “twofold” encrypted content to the second user.

As readily seen, in this embodiment again, the two third parties may be replaced with a single third party equipped with a computer capable of fulfilling the functions performed by the two data-processing apparatuses 72 and 74.

In accordance with the present invention, the systems of FIGS. 6 and 7 may be combined into a single system. In this system, a first user may receive encrypted versions of content from a number of content distributors, as described below, and combines the received contents into a single volume to be send to a second user. The detailed features of the system are as follows.

The system may involve first and second content distributors, first and second users, and 1st˜3rd third parties. The 1st third party is trusted by both the first content distributor and the first user. The 2nd third party is trusted by both the second content distributor and the second user. The 3rd third party is trusted by both the first user and the second user. Each of the two users and three third parties is provided with a data-processing apparatus. These data-processing apparatuses are connected to each other via a communications network for example.

In accordance with the system, the first content distributor sends an encrypted version of content (“first content”) to the data-processing apparatus of the first user, while the second content distributor sends another encrypted version of content (“second content”) to the data-processing apparatus of the first user.

Upon receiving the encrypted first content, the first user decodes it to retrieve the plaintext version of the first content (as in the system of FIG. 6). The first user may or may not modify the plaintext first content. Upon receiving the encrypted second content, on the other hand, the first user does not decode it (as in the system of FIG. 7). The first user combines the plaintext first content and the encrypted second content into a single volume (“third content”), and then encrypts the third content. After this encryption, the third content is sent to the second user.

To enable such procedures, the following features are provided for the system.

The data-processing apparatus of the first user incorporates a first tamper-resistant device, and the data-processing apparatus of the second user incorporates a second tamper-resistant device.

The data-processing apparatus of the 1st third party supplies the first user's data-processing apparatus with first data relating to a first decrypting key to decode the encrypted first content from the first contributor. Based on this first data, the first tamper-resistant device produces the first decrypting key with which the decoding of the first content is performed. The first decrypting key is produced only by the first tamper-resistant device and kept confidential within the device.

The above-mentioned plaintext first content and the encrypted second content are put together as “third content” by the data-processing apparatus of the first user, and then encrypted. The encrypted third content is sent to the data-processing apparatus of the second user.

To retrieve the plaintext first and second contents from the encrypted third content, a second decrypting key and a third decrypting key are employed. First, with the use of the third decrypting key, the second tamper-resistant device of the second user performs the decoding of the third content. This uncovers the encryption of the third content, whereby the hidden contents, i.e., the plaintext first content and the encrypted second content are revealed. Thereafter, with the use of the second decrypting key, the second tamper-resistant device performs the decoding of the encrypted second content, to retrieve the plaintext second content.

For effecting the above features, the following system arrangements are made.

To decode the encrypted third content, the 3rd third party's data-processing apparatus supplies the second user's data-processing apparatus with data relating to the third decrypting key to decode the encrypted third content. More specifically, based on the supplied data, the second tamper-resistant device produces the third decrypting key. Advantageously, this key is obtained only by the second tamper-resistant device and kept confidential within the device. With the third decrypting key, the second tamper-resistant device decodes the encrypted third content, which yields the plaintext first content and the encrypted second content.

To decode the encrypted second content, the 2nd third party's data-processing apparatus provides the second user's data-processing apparatus with data relating to the second decrypting key to decode the encrypted second content. Based on the supplied data, the second tamper-resistant device produces the second decrypting key, which is also obtained only by the second tamper-resistant device and kept confidential within the device. With the second decrypting key, the second tamper-resistant device-resistant device decode the encrypted second content.

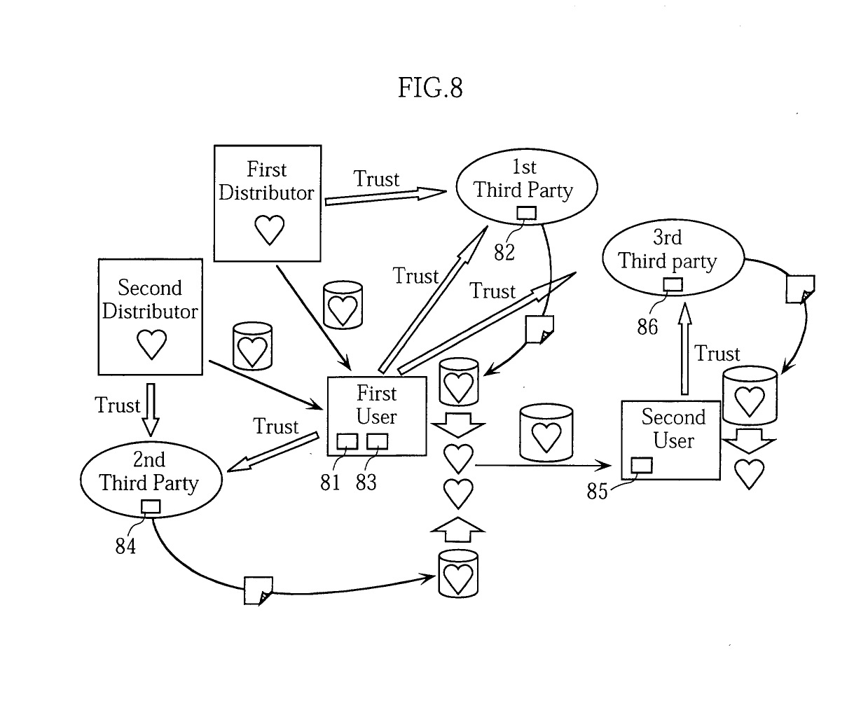

Reference is now made to FIG. 8 illustrating the basic concept of a content distribution system according to another embodiment of the present invention. In accordance with this system, as will be described in detail below, a single first user receives contents supplied from two or more content distributors. Then, the first user combines these contents to produce a new volume of content, and sends it to the second user.

As shown in FIG. 8, the distribution system may involve first and second content distributors, first and second users, and 1st˜3rd third parties. The 1st third party is trusted by both the first content distributor and the first user. The 2nd third party is trusted by both the second content distributor and the first user. The 3rd third party is trusted by both the first user and the second user.

The first user is provided with first and second data-processing apparatuses 81, 83. Likewise, the second user is provided with a data-processing apparatus 85, the 1st third party with a data-processing apparatus 82, the 2nd third party with a data-processing apparatus 84, and the 3rd third party with a data- processing apparatus 86. These data-processing apparatuses 81˜86 are connected to each other via a suitable communications network.

The first data-processing apparatus 81 of the first user receives an encrypted first content supplied from the first content distributor, while the second data-processing apparatus 83 of the same user receives another encrypted second content supplied from the second content distributor. These supplied contents are decrypted by the data-processing apparatuses. Then, these data-processing apparatuses produce a third content from the plaintext first and second contents. In creating the third content, the two plaintext contents may be suitably modified. Then, the third content is encrypted by the data-processing apparatuses, and supplied to the data-processing apparatus 85 of the second user.

To retrieve the plaintext third content, the following arrangements are made.

The first data-processing apparatus 81 of the first user is provided with a first tamper-resistant device, while the second data-processing apparatus 83 of the first user is provided with a second tamper-resistant device. Further, the data-processing apparatus 85 of the second user is provided with a third tamper-resistant device. These first to third tamper-resistant devices may be the same as the one shown in FIG. 2.

The data-processing apparatus 82 of the 1st third party supplies the first data-processing apparatus 81 of the first user with first data relating to a first decrypting key to decode the encrypted first content. Based on the first data, the first tamper-resistant device produces the first decrypting key, which is obtained only by the first tamper-resistant device and kept confidential within it. With the use of this first decrypting key, the first tamper-resistant device decodes the encrypted first content from the first distributor.

Similarly, the data-processing apparatus 84 of the 2nd third party supplies the second data-processing apparatus 83 of the first user with second data relating to a second decrypting key to decode the encrypted second content. Based on the second data, the second tamper-resistant device produces the second decrypting key, which is obtained only by the second tamper-resistant device and kept confidential within it. With the use of this second decrypting key, the second tamper-resistant device decodes the encrypted second content.

The data-processing apparatus 86 of the 3rd third party supplies the data-processing apparatus 85 of the second user with third data relating to a third decrypting key to decode the encrypted third content. Based on the third data, the third tamper-resistant device produces the third decrypting key, which is obtained only by the third tamper-resistant device and kept confidential within it. With the use of this third decrypting key, the third tamper-resistant device of the second user decodes the encrypted third content.

According to the present invention, the 1st˜3rd third parties in the above embodiment may partially or entirely be replaced with a single third party. Accordingly, the data-processing apparatuses 82, 84 and 86 may partially or entirely be replaced with a single computer. It is also possible to replace the first and second data-processing apparatuses 81, 83 of the first user with a single computer.

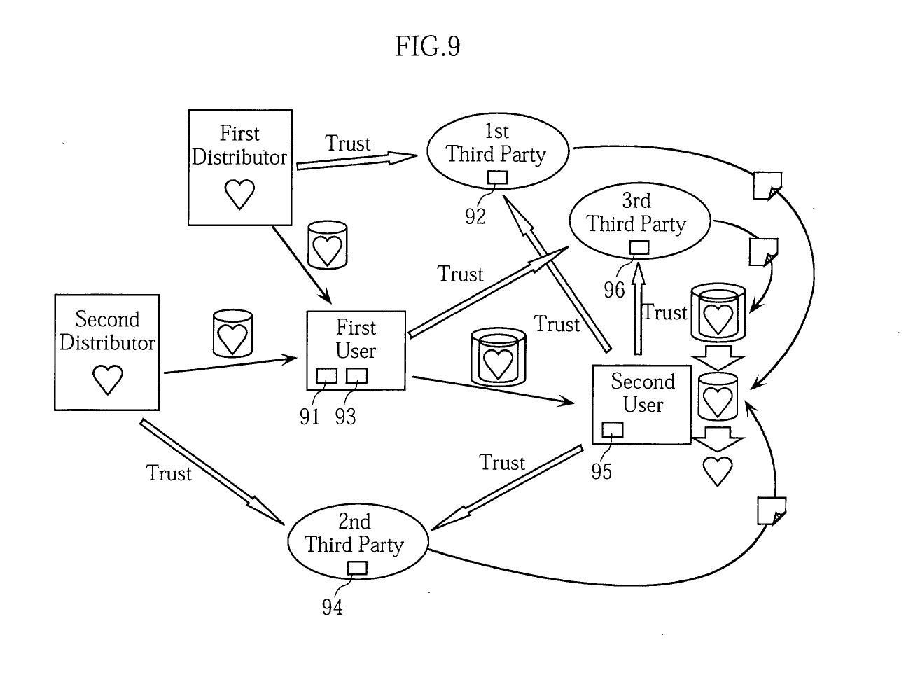

FIG. 9 illustrates the basic concept of a content distribution system according to another embodiment of the present invention. In accordance with this system again, contents supplied from several distributors are combined by a first user into a single volume, and then sent to a second user. Differing from the previous system (FIG. 8), however, the combining of the contents sent to the first user is performed without the supplied contents being decrypted by the first user.

As shown in FIG. 9, the system involves first and second content distributors, first and second users, and 1st˜3rd third parties. The 1st third party is trusted by both the first distributor and the second user. The 2nd third party is trusted by both the second distributor and the second user. The 3rd third party is trusted by both the first user and the second user.

The first user is provided with first and second data-processing apparatuses 91 and 93, while the second user is provided with a data-processing apparatus 95. Likewise, the 1st, 2nd and 3rd third parties are provided with data-processing apparatuses 92, 94 and 96, respectively. These data-processing apparatuses 91˜96 are connected to each other via a communications network.

The first data-processing apparatus 91 of the first user receives an encrypted first content supplied from the first contributor. The second data-processing apparatus 93 of the first user receives an encrypted second content supplied from the second contributor.

The above two data-processing apparatuses of the first user produces a third content based on the first and second contents. Then, the data-processing apparatuses encrypt the third content and send it to the data-processing apparatus 95 of the second user. The data-processing apparatus 95 of the second user incorporates a tamper-resistant device like the one shown in FIG. 2.

The data-processing apparatus 92 of the 1st third party supplies the second user's data-processing apparatus 95 with first data relating to a first decrypting key to decode the encrypted first content from the first content distributor. Based on this first data, the first decrypting key is obtained only by and kept confidential within the tamper-resistant device incorporated in the second user's data-processing apparatus 95.

The data-processing apparatus 94 of the 2nd third party supplies the second user's data-processing apparatus 95 with second data relating to a second decrypting key to decode the encrypted second content from the second content distributor. Based on this second data, the second decrypting key is obtained only by and kept confidential within the tamper-resistant device incorporated in the second user's data-processing apparatus 95.

The data-processing apparatus 96 of the 3rd third party supplies the second user's data-processing apparatus 95 with third data relating to a third decrypting key to decode the encrypted third content from the first user. Based on this third data, the third decrypting key is obtained only by and kept confidential within the tamper-resistant device incorporated in the second user's data-processing apparatus 95.

With the use of the third decrypting key, the tamper-resistant device incorporated in the second user's data-processing apparatus 95 decodes the third content encrypted by the first user. As a result, the encrypted first content and the encrypted second content are retrieved. Thereafter, the same tamper-resistant device decodes the encrypted first and second contents with the use of the first and the second decrypting keys.

According to the present invention, the systems of FIGS. 8 and 9 may be combined into a single system, whereby encrypted contents from some particular distributors are decoded by a first user, while encrypted contents from other distributors are not decoded by the first user. The first user combines all the contents (the decrypted and nondecrypted ones) into a single volume, and encrypts it. Then, the encrypted volume is sent to a second user.

To effect the above procedure, the system may involve first˜fourth content distributors, first and second users, and 1st˜5th third parties.

The 1st third party is trusted by both the first content distributor and the first user. The 2nd third party is trusted by both the second content distributor and the first user. The 3rd third party is trusted by both the third content distributor and the second user. The 4th third party is trusted by both the fourth content distributor and the second user. The 5th third party is trusted by both the first user and the second user.

The first user is provided with first˜fourth data-processing apparatuses. Likewise, each of the second user and 1st˜5th third parties is provided with a data-processing apparatus. All the data-processing apparatuses are connected to each other via a communications network.

The first and the second data-processing apparatuses of the first user are provided with first and second tamper-resistant devices, respectively. Likewise, the data-processing apparatus of the second user is provided with a third tamper-resistant device.

The first data-processing apparatus of the first user receives an encrypted first content from the first content distributor. The second data-processing apparatus of the first user receives an encrypted second content from the second content distributor. The third data-processing apparatus of the first user receives an encrypted third content from the third content distributor. The fourth data-processing apparatus of the first user receives an encrypted fourth content from the fourth content distributor.

The data-processing apparatus of the second user receives an encrypted fifth content from the first user. The non-encrypted fifth content is produced by the first user based on the first and the second contents as plaintext and the encrypted third and fourth contents.

The 1st third party supplies the first data-processing apparatus of the first user with first data relating to a first decrypting key to decode the encrypted first content. Based on the first data, the first decrypting key is obtained only by and kept confidential within the first tamper-resistant device of the first data-processing apparatus. With the use of the first decrypting key, the first tamper-resistant device decodes the encrypted first content.

The data-processing apparatus of the 2nd third party supplies the second data-processing apparatus of the first user with second data relating to a second decrypting key to decode the encrypted second content. Based on the second data, the second decrypting key is obtained only by and kept confidential within the second tamper-resistant device of the second data-processing apparatus. With the use of the second decrypting key, the second tamper-resistant device decodes the encrypted second content.

The data-processing apparatus of the 3rd third party supplies the data-processing apparatus of the second user with third data relating to a third decrypting key to decode the encrypted third content. Based on the third data, the third decrypting key is obtained only by and kept confidential within the third tamper-resistant device.

The data-processing apparatus of the 4th third party supplies the data-processing apparatus of the second user with fourth data relating to a fourth decrypting key to decode the encrypted fourth content. Based on the fourth data, the fourth decrypting key is obtained only by and kept confidential within the third tamper-resistant device.

The data-processing apparatus of the 5th third party supplies the data-processing apparatus of the second user with fifth data relating to a fifth decrypting key to decode the encrypted fifth content. Based on the fifth data, the fifth decrypting key is obtained only by and kept confidential within the third tamper-resistant device.

With the use of the fifth decrypting key, the third tamper-resistant device decodes the encrypted fifth content. As a result, the encrypted third content and the encrypted fourth content are retrieved. Then, with the use of the third and the fourth decrypting keys, the third tamper-resistant device decodes the encrypted third content and the encrypted fourth content.

According to the present invention, as described above, the decrypting key to decode the desired content is obtained only by a tamper-resistant device and kept confidential in the device. Thus, unauthorized distribution of a content-decrypting key is reliably prevented.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A content distribution system comprising:
a data-processing apparatus of a user for receiving a content supplied from a content distributor;
a data-processing apparatus of a third party trusted by both the content distributor and the user; and
a communications network connecting the data-processing apparatuses of the user and the third party for mutual data communication;
wherein the data-processing apparatus of the user is provided with a tamper-resistant device storing data inaccessible from outside;
wherein the data-processing apparatus of the third party transmits first data to the data-processing apparatus of the user, the first data relating to a decrypting key that decodes a cipher generated by the content distributor, the decrypting key being obtained only within the tamper-resistant device; and
wherein the tamper-resistant device decodes the cipher by using the first data from the data-processing apparatus of the third party.

2. A content distribution system comprising:
a data-processing apparatus of a content distributor that transmits a content;
a data-processing apparatus of a user that receives the content;
a data-processing apparatus of a third party trusted by both the content distributor and the user; and
a communications network connecting the data-processing apparatuses of the content distributor, the user and the third party for mutual data communication;
wherein the data-processing apparatus of the content distributor supplies a cipher to the data-processing apparatus of the user;
wherein the data-processing apparatus of the user is provided with a tamper-resistant device storing data inaccessible from outside;
wherein the data-processing apparatus of the third party transmits first data to the data-processing apparatus of the user, the first data relating to a decrypting key that decodes the cipher, the decrypting key being obtained only within the tamper-resistant device; and
wherein the tamper-resistant device decodes the cipher by using the first data from the data-processing apparatus of the third party.

3. The system according to claim 2, wherein the data-processing apparatus of the third party stores a public key and a secret key, the public key being transmitted to the data-processing apparatus of the content distributor as required by the data-processing apparatus of the content distributor;
wherein the data-processing apparatus of the content distributor encodes the decrypting key by using the public key from the data-processing apparatus of the third party, the encoded decrypting key being transmitted to the data-processing apparatus of the user;
wherein the data-processing apparatus of the user causes the tamper-resistant device to generate second data based on the encoded decrypting key from the data-processing apparatus of the content distributor, the second data being transmitted to the data-processing apparatus of the third party; and
wherein the data-processing apparatus of the third party generates the first data based on the secret key and the second data supplied from the data-processing apparatus of the user.

4. The system according to claim 3, further comprising an additional third party, wherein the tamper-resistant device divides the second data into pieces one of which is received by a relevant one of the third parties.

5. The system according to claim 3, wherein the tamper-resistant device allows mixing of a random number component in generating the second data based on the encoded decrypting key, while also allowing removal of the random number component from the first data in decoding the cipher by using the first data.

6. The system according to claim 2, wherein the tamper-resistant device stores information on the public key in a form of a digital certificate by an authentication agency, the tamper-resistant device being supplied to the user after the user is identified by the authentication agency; and
wherein the data-processing apparatus of the third party confirms the identification of the user based on the public key information supplied in the form of the digital certificate from the data-processing apparatus of the user.

7. A tamper-resistant device used in a content distribution system, the system comprising a data-processing apparatus of a content distributor to supply an encrypted content, a data-processing apparatus of a user to receive the supplied content, a data-processing apparatus of a third party which is trusted by both the content distributor and the user and supplies data on a key to decode the encrypted content, and a communications network connecting the respective data-processing apparatuses to each other for mutual data communication, the tamper-resistant device comprising:
a memory storing data inaccessible from outside; a key obtainer that restores the decoding key based on the key data supplied from the data-processing apparatus of the third party; and
a decoder that decodes the encrypted content by using the decoding key restored by the key obtainer.

8. A server used in a content distribution system, the system comprising a data-processing apparatus of a content distributor to supply an encrypted content, a data-processing apparatus of a user to receive the supplied content, a data-processing apparatus of a third party trusted by both the content distributor and the user, a communications network connecting the respective data-processing apparatuses to each other for mutual data communication, and a tamper-resistant device provided on the data-processing apparatus of the user for storing data inaccessible from outside, the server working as the data-processing apparatus of the third party, the server comprising:
a data generator that generates first data relating to a key to decode the encrypted content from the data-processing apparatus of the content distributor, the decoding key being generated only within the tamper-resistant device; and
a data distributor that sends the first data to the data-processing apparatus of the user via the communications network.

9. A computer program used in a content distribution system, the system comprising a data-processing apparatus of a content distributor to supply an encrypted content, a data-processing apparatus of a user to receive the supplied content, a data-processing apparatus of a third party trusted by both the content distributor and the user, a communications network connecting the data-processing apparatuses of the content distributor, the user and the third party for mutual data communication, and a tamper-resistant device provided on the data-processing apparatus of the user, the tamper-resistant device storing data inaccessible from outside, the computer program being prepared for controlling the data-processing apparatus of the third party, the computer program comprising:
a data generation program for generating first data relating to a key that decodes the encrypted content from the data-processing apparatus of the content distributor, the decoding key being generated only within the tamper-resistant device; and
a data transmission program for sending the first data to the data-processing apparatus of the user via the communication network.

10. A content distribution process performed in a system that comprises a data-processing apparatus of a user to receive an encrypted content supplied from a content distributor, a data-processing apparatus of a third party trusted by both the content distributor and the user, and a communications network connecting the data-processing apparatuses of the user and the third party for mutual data communication, the content distribution process comprising the steps of:
causing the data-processing apparatus of the user to issue an instruction to the data-processing apparatus of the third party for carrying out a procedure to make a payment for the content;
causing the data-processing apparatus of the third party to send first data to the data-processing apparatus of the user when the payment for the content is made from an account of the user to an account of the third party, the first data serving to provides a key that decodes the encrypted content, the decoding key being available only within the data-processing apparatus of the user; and
causing the data-processing apparatus of the user to decode the encrypted content using the first data supplied from the data-processing apparatus of the third party.

11. The process according to claim 10, wherein the data-processing apparatus of the user is provided with a tamper-resistant device that stores data inaccessible from outside, the decoding of the encrypted content being performed by the tamper-resistant device.

12. The process according to claim 10, wherein the data-processing apparatus of the third party stores a public key and a secret key,
wherein the data-processing apparatus of the user generates second data based on the decoding key, the decoding key being supplied from the content distributor and encrypted by the public key, the second data being transmitted to the data-processing apparatus of the third party, and
wherein the data-processing apparatus of the third party generates the first data based on the second data and the secret key.

13. The process according to claim 12, wherein the data-processing apparatus of the user allows mixing of a random number component in generating the second data based on the encrypted decoding key, the random number component being removed from the first data when the first data decodes the encrypted content.

14. The process according to claim 13, wherein the tamper-resistant device generates the second data and decodes the encrypted content.

15. The process according to claim 10, wherein the data-processing apparatus of the third party carries out the payment procedure from the account of the third party to the account of the content distributor when the data-processing apparatus of the third party receives content confirmation notice from the data-processing apparatus of the user.

16. A content distribution system comprising:
a data-processing apparatus of a first user for receiving an encrypted version of a first content as plaintext from a content distributor;
a data-processing apparatus of a 1st third party trusted by both the distributor and the first user;
a data-processing apparatus of a second user for receiving an encrypted version of a second content as plaintext from the first user, the second content being produced based on the plaintext first content;
a data-processing apparatus of a 2nd third party trusted by both the first user and the second user; and
a communications network for connecting the data-processing apparatuses to each other;
wherein the data-processing apparatus of the first user is provided with a first tamper-resistant device storing data inaccessible from outside, the data-processing apparatus of the second user being provided with a second tamper-resistant device storing data inaccessible from outside;
wherein the data-processing apparatus of the 1st third party supplies the data-processing apparatus of the first user with first data relating to a first decrypting key to decode the encrypted first content from the distributor, the first decrypting key being obtainable only within the first tamper-resistant device with the use of the first data;
wherein the first tamper-resistant device decodes the encrypted first content with the use of the first data from the data-processing apparatus of the 1st third party;
wherein the data-processing apparatus of the 2nd third party supplies the data-processing apparatus of the second user with second data relating to a second decrypting key to decode the encrypted second content from the first user, the second decrypting key being obtainable only within the second tamper-resistant device with the use of the second data; and
wherein the second tamper-resistant device decodes the encrypted second content with the use of the second data from the data-processing apparatus of the 2nd third party.

17. A content distribution system comprising:
a data-processing apparatus of a first user for receiving an encrypted version of a first content as plaintext from a content distributor;
a data-processing apparatus of a second user for receiving an encrypted version of a second content from the first user, the second content being produced based on the encrypted first content;
a data-processing apparatus of a 1st third party trusted by both the distributor and the second user;
a data-processing apparatus of a 2nd third party trusted by both the first user and the second user; and
a communications network for connecting the data-processing apparatuses to each other;
wherein the data-processing apparatus of the second user is provided with a tamper-resistant device storing data inaccessible from outside;
wherein the data-processing apparatus of the 1st third party supplies the data-processing apparatus of the second user with first data relating to a first decrypting key to decode the encrypted first content from the distributor, the first decrypting key being obtainable only within the tamper-resistant device;
wherein the data-processing apparatus of the 2nd third party supplies the data-processing apparatus of the second user with second data relating to a second decrypting key to decode the encrypted second content from the first user, the second decrypting key being obtainable only within the tamper-resistant device; and
wherein the tamper-resistant device decodes the encrypted second content with the use of the second data from the 2nd third party so that the encrypted first content is retrieved, the tamper-resistant device further decoding the encrypted first content with the use of the first data from the 1st third party.

18. A content distribution system comprising:
a data-processing apparatus of a first user both for receiving an encrypted version of a first content as plaintext from a first content distributor and for receiving an encrypted version of a second content as plaintext from a second content distributor;
a data-processing apparatus of a 1st third party trusted by both the first distributor and the first user;
a data-processing apparatus of a second user for receiving a third content from the first user, the third content being produced based on both the plaintext first content and the encrypted second content;
a data-processing apparatus of a 2nd third party trusted by both the second distributor and the second user;
a data-processing apparatus of a 3rd third party trusted by both the second distributor and the second user; and
a communications network for connecting the data-processing apparatuses to each other;
wherein the data-processing apparatus of the first user is provided with a first tamper-resistant device storing data inaccessible from outside, the data-processing apparatus of the second user being provided with a second tamper-resistant device storing data inaccessible from outside;
wherein the data-processing apparatus of the 1st third party supplies the data-processing apparatus of the first user with first data relating to a first decrypting key to decode the encrypted first content from the first distributor, the first decrypting key being obtainable only within the first tamper-resistant device;
wherein the first tamper-resistant device decodes the encrypted first content with the use of the first data from the 1st third party;
wherein the data-processing apparatus of the 2nd third party supplies the data-processing apparatus of the second user with second data relating to a second decrypting key to decode the encrypted second content from the second distributor, the second decrypting key being obtainable only within the second tamper-resistant device;
wherein the data-processing apparatus of the 3rd third party supplies the data-processing apparatus of the second user with third data relating to a third decrypting key to decode the encrypted third content from the first user, the third decrypting key being obtainable only within the second tamper-resistant device;
wherein the second tamper-resistant device decodes the encrypted third content with the use of the third data from the 3rd third party, the second tamper-resistant device further decoding the encrypted second content with the use of the second data from the 2nd third party, the encrypted second content resulting from the decoding of the encrypted third content.

19. A content distribution system comprising:
a first data-processing apparatus of a first user for receiving an encrypted version of a first content as plaintext from a first content distributor;
a data-processing apparatus of a 1st third party trusted by both the first contributor and the first user;
a second data-processing apparatus of the first user for receiving an encrypted version of a second content as plaintext from a second content distributor;
a data-processing apparatus of a 2nd third party trusted by both the second distributor and the first user;
a data-processing apparatus of a second user for receiving an encrypted version of a third content from the first user, the third content being produced based on both the plaintext first content and the plaintext second content;
a data-processing apparatus of a 3rd third party trusted by both the first user and the second user; and
a communications network for connecting the data-processing apparatuses to each other;
wherein the first data-processing apparatus of the first user is provided with a first tamper-resistant device storing data inaccessible from outside, the second data-processing apparatus of the first user being provided with a second tamper-resistant device storing data inaccessible from outside;
wherein the data-processing apparatus of the second user is provided with a third tamper-resistant device storing data inaccessible from outside;
wherein the data-processing apparatus of the 1st third party supplies the first data-processing apparatus of the first user with first data relating to a first decrypting key to decode the encrypted first content from the first distributor, the first decrypting key being obtainable only within the first tamper-resistant device;
wherein the first tamper-resistant device decodes the encrypted first content with the use of the first data from the 1st third party;
wherein the data-processing apparatus of the 2nd third party supplies the second data-processing apparatus of the first user with second data relating to a second decrypting key to decode the encrypted second content from the second distributor, the second decrypting key being obtainable only within the second tamper-resistant device;
wherein the second tamper-resistant device decodes the encrypted second content with the use of the second data from the 2nd third party;
wherein the data-processing apparatus of the 3rd third party supplies the data-processing apparatus of the second user with third data relating to a third decrypting key to decode the encrypted third content from the first user, the third decrypting key being obtainable only within the third tamper-resistant device;
wherein the third tamper-resistant device decodes the encrypted third content with the use of the third data from the 3rd third party.

20. A content distribution system comprising:
a first data-processing apparatus of a first user for receiving an encrypted version of a first content as plaintext from a first content distributor;
a second data-processing apparatus of the first user for receiving an encrypted version of a second content as plaintext from a second content distributor;
a data-processing apparatus of a second user for receiving an encrypted version of a third content from the first user, the third content being produced based on both the encrypted first content and the encrypted second content;
a data-processing apparatus of a 1st third party trusted by both the first distributor and the second user;
a data-processing apparatus of a 2nd third party trusted by both the second distributor and the second user;
a data-processing apparatus of a 3rd third party trusted by both the first user and the second user; and
a communications network for connecting the data-processing apparatuses to each other;
wherein the data-processing apparatus of the second user is provided with a tamper-resistant device storing data inaccessible from outside;
wherein the data-processing apparatus of the 1st third party supplies the data-processing apparatus of the second user with first data relating to a first decrypting key to decode the encrypted first content from the first distributor, the first decrypting key being obtainable only within the tamper-resistant device;
wherein the data-processing apparatus of the 2nd third party supplies the data-processing apparatus of the second user with second data relating to a second decrypting key to decode the encrypted second content from the second distributor, the second decrypting key being obtainable only within the tamper-resistant device;
wherein the data-processing apparatus of the 3rd third party supplies the data-processing apparatus of the second user with third data relating to a third decrypting key to decode the encrypted third content from the first user, the third decrypting key being obtainable only within the tamper-resistant device;
wherein the tamper-resistant device decodes the encrypted third content from the first user with the use of the third data from the 3rd third party, the tamper-resistant device further performing additional decoding on the decoded third content with the use of the first data from the 1st third party and the second data from the 2nd third party.
